(19) United States
(12) Patent Application Publication
(10) Pub. No.: US 2006/0023204 A1
(43) Pub. Date: Feb. 2, 2006

(54) Laser-GPS marking and targeting system

(76) Inventor: Zoltan Filep, Turlock, CA (US)

Correspondence Address: ZOLTAN FILEP, 300 WILEY CT., TURLOCK, CA, 95382, US

(21) Appl. No.: 11/190,583

(22) Filed: Jul. 27, 2005

Related U.S. Application Data
(60) Provisional application No. 60/591,727, filed on Jul. 28, 2004.

(51) Int. Cl. G01C 1/00; G01C 3/08; G01B 11/26; G01S 1/00

(52) U.S. Cl. 356/139.01; 342/357.01; 356/139.1; 356/4.01

(57) ABSTRACT

What is new in this invention, it is the complete automation of coordinate data collection of remote target objects. It is also a new procedure a single measurement instead of multiple triangulation measurements for coordinate data collection.

A combined method is provided for non invasive and non contact laser and/or GPS marking for processing of targeted objects.

The target object viewing, selection, marking, together with information acquisition, processing and transmission is done by the equipment.

### BACKGROUND OF THE INVENTION

Observation and marking is an important component in the processing of objects. The GPS coordinates and other additional information are essential in modem fire management.

Existing equipment and systems are giving bits of information about a target. All these information, not being in a compact package, are hard to process, giving the possibility for errors to occure.

It is useful and even necessary to have a clear, possibly computerized collection and processing of as much information as possible.

This information has to be collected and packed from the field and transmitted to the fire management or other process control unit.

A higher level of information integration and more versatile data acquisition equipment is necessary.

### SUMMARY OF THE INVENTION

The invention is directed to increase the efficiency of existing laser marking and targeting systems, helping also decision making and process control.

The invention, the laser-GPS marking and targeting system, is getting a visual information of the target, is calculating the target object's GPS coordinates, motion information like direction and speed and it is transmitting them to the headquarter.

The invention can execute in the same time other operations too, like taking digital pictures and/or laser marking of the targeted object for immediate processing.

The invention can be operated by a human operator or can be installed on different equipment, like a robot, an UAV/drone or helicopter.

### BRIEF DESCRIPTION OF THE DRAWINGS

FIG. 1 is a general view of the relation between the observer/origin and the target object.

FIG. 2 is an image of the 4 major positions relatively to the origin.

FIG. 3 is an image of motion vector calculation thru 2 consecutive readings.

FIG. 4 is a picture of the 3rd dimension calculation in 3D GPS.

FIG. 5 is an example of technical solution for the invention.

### DETAILED DESCRIPTION OF THE INVENTION

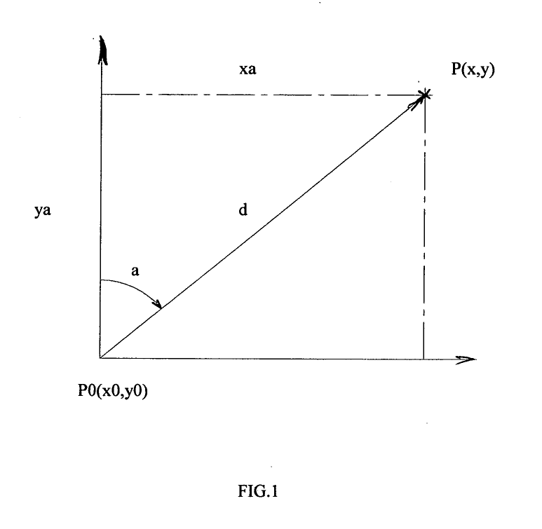

FIG. 1 is a general view of the relation between the observer/origin P0(x0,y0) and the target object P(x,y).

xa and ya—are horizontal and vertical components of the distance d from the origin to the target.

The value of the distance d is given by the laser range finder or any other distance reading equipment/module.

a—is the angular direction towards North, value given by a digital compass, by example.

This way, we have the values:
Xa=d*sin a
Ya=d*cos a

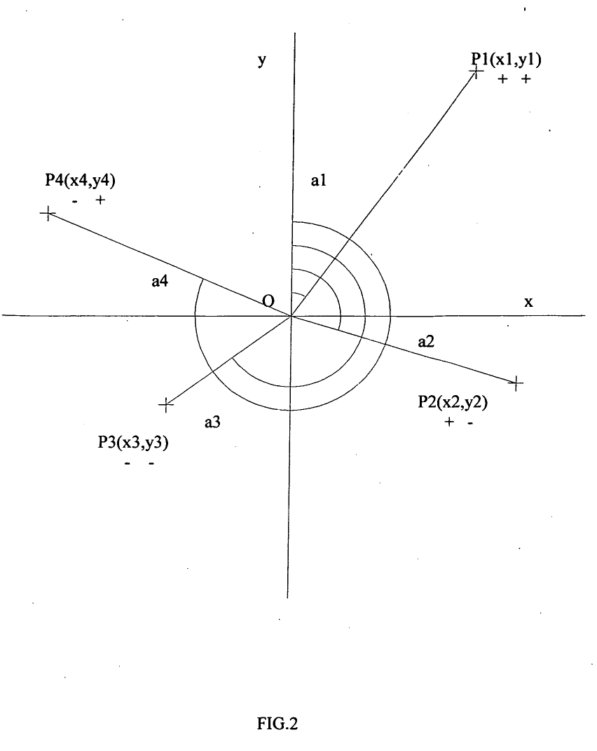

We can observe from FIG. 2, that the sign of the x and y coordinates is following the sign of the sin a and cos a functions, thru the 4 quadrants.

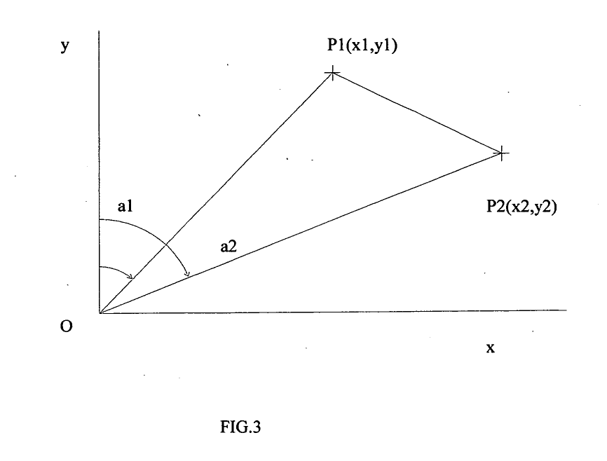

Making 2 consecutive readings, like in FIG. 3, we can determine motion vector parameters of the target, or we can simply forward the readings to the central processing unit.

The resulting global distance values are:

for the northern hemisphere
x=x0+xa=x0+d*sin a
y=y0+ya=y0+d*cos a
for the southern hemisphere
x=x0+xa=x0+d*sin a
y=y0−ya=y0−d*cos a

We will continue with the calculus for the northern hemisphere, for the southern one the corrections being easy to make thru analogy.

Converting the distances x and y into longitudes and latitudes, we get the coordinates for the target P(lon,lat):
Lon=lon0+k1*xa
Lat=lat0+k2*ya
where P0(lon0,lat0) is the observer, with the lon0 and lat0 GPS coordinates, given by a GPS module.
k1 and k2 are conversion coefficients from distances to GPS angular values and they are depending on the location on the globe, actually the P0(lon0,lat0). They also include magnetic to geographic North correction values.
2D coordinates

If we have a 2D GPS module, or no altitude reading, the P(lon,lat) will have:
Lon=lon0+k1*xa=lat0+k1*d*sin a
Lat=lat0+k2*ya=lon0+k2*d*cos a
3D coordinates

If we have a 3D GPS module, or an altitude reading, the altitude will be the third factor, besides longitude and latitude.

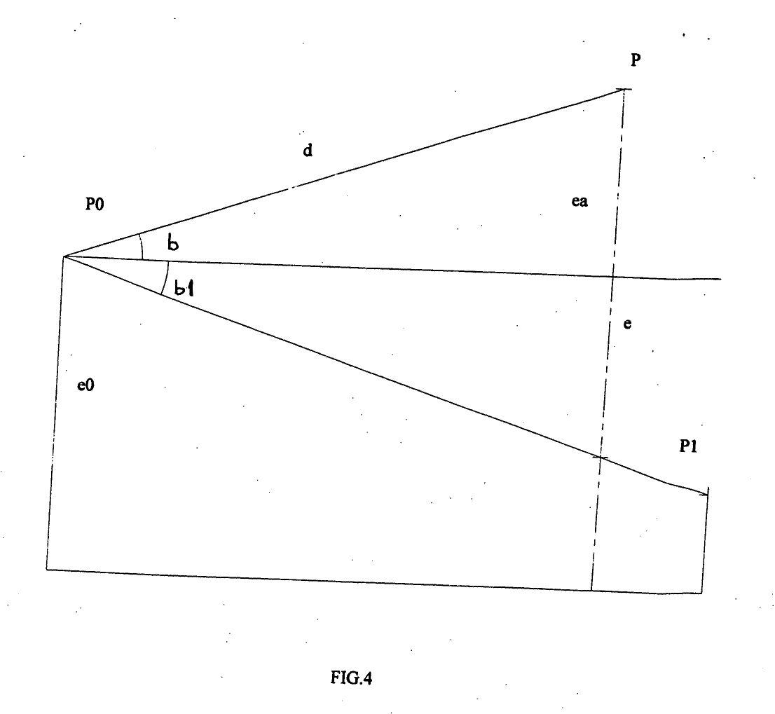

FIG. 4 is representing the altitude/elevation computing, with the observer P0 at elevation e0 and the target P at elevation ea:
E=e0+ea=e0+d*sin b,
where b is an angular value, reading given by a digital incline-o-meter, or any similar device/module.

The 3D coordinates for the target P will be:
Lon=lon0+k1*d*sin a
Lat=lat0+k2*d*cos a
E=e0+d*sin b

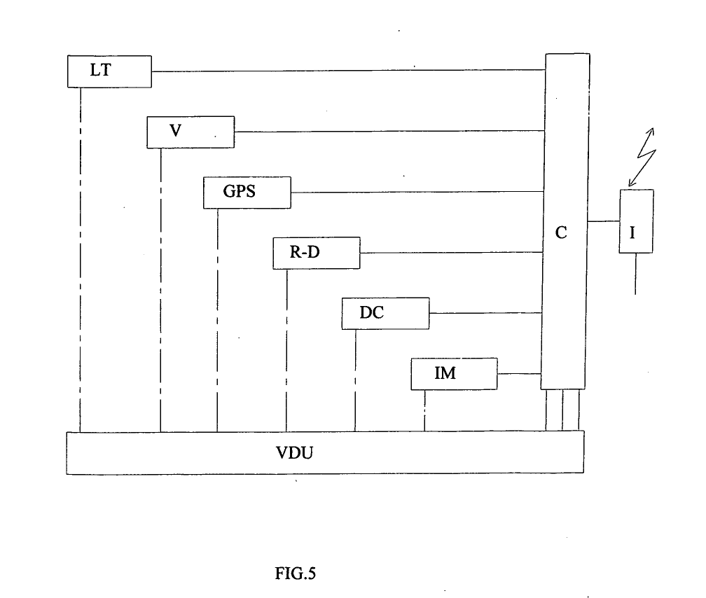

FIG. 5 is an example of technical solution for the invention.
LT is a laser marking and targeting module, output, for immediate processing of the target. It is optional, but very useful.
V is the video input of the system, by example a digital camera.
GPS is a GPS input module, used to establish the observer's GPS coordinates.
R-D is a range or distance finder, input, by example a laser range finder for the distance to the target.
DC is a digital compass, for the azimuth input.
IM is an incline-o-meter, input, to calculate the elevation of the target.

All these modules, excepting LT, are sending their readings to the computer C. The computer C is calculating the target object's coordinates and motion vector data. All the input data and output data are displayed directly or indirectly on VDU—the video display unit; they are also sent to the process control unit via the interface I.

The system described above is not strictly defined, it is just an example.

It should be understood that the invention is not intended to be limited by the specifics of the above described embodiments, but rather defined by the operating principles.

I claim:

1. A non invasive and non contact method for laser and GPS marking for processing of one or more remote target objects, comprising projecting information vectors on the surface of said target objects, said reflected information vectors are used in conjunction with locally collected data to establish GPS coordinates of said remote targeted objects.

2. The method as of claim 1, wherein said information vector is having the primary role in the establishing of the distance between the point of origin and said target objects.

3. The method as of claim 1, wherein said information vector is having a secondary role as a selector and identifier for each separate marking system out of a multitude of marking systems for avoiding overlapping.

4. The method as of claim 1, wherein said locally collected data is an information package comprising:
a video information means for visual data related to the said target objects and the surrounding environment, and
a coordinates information means for establishing the observer's/origin's initial coordinates, and
a distance information means for establishing the distance from the origin to the said target object(s), and
an azimuth information means for establishing the angular position of the said target object(s) relatively to the point of origin, and
an inclination information means for establishing the angular deviation to the horizontal between the said point of origin and said target objects, and
an altitude information means of the said point of origin if no 3D coordinates available.

5. A system for laser and GPS marking for processing of one or more remote target objects comprising:
an input block means composed of;
a video input means for the visual information collection of the said remote target objects, and
a GPS input means for the establishing of the point of origin's 2D or 3D coordinates, and
a range or distance finder means for the establishing of the distance's from the point of origin to the target object(s), and
an azimuth input means for the establishing of the angular position of the said remote target objects, and
an angular tilting input means for the establishing the elevation of the target objects, and
an altitude input for the establishing the point of origin's elevation, if only 2D GPS data are available;
a computing means for calculations and controls;
a display means for operator interfacing;
an interface means for external communications;
a laser targeting module for marking for immediate processing.

6. The system as claimed in claim 5, wherein said video input means is aligned to the said range or distance finder means.

7. The system as claimed in claim 5, wherein video input means is also aligned to the said display means of operator interface.

8. The system as claimed in claim 5, wherein said video input means is also aligned to the said laser targeting module means.

9. The system as claimed in claim 5, wherein said video input means is also aligned to the said angular tilting input means.
